(19) United States
(12) Patent Application Publication
(10) Pub. No.: US 2020/0005422 A1
(43) Pub. Date: Jan. 2, 2020

(54) SYSTEM AND METHOD FOR USING IMAGES FOR AUTOMATIC VISUAL INSPECTION WITH MACHINE LEARNING

(71) Applicant: Photogauge, Inc., Alamo, CA (US)

(72) Inventors: Sankara J. SUBRAMANIAN, Chennai (IN); Azhar H. KHAN, Alamo, CA (US); Sameer SHARMA, Chennai (IN); Mazhar SHAIKH, Chennai (IN)

(21) Appl. No.: 16/131,456

(22) Filed: Sep. 14, 2018

Related U.S. Application Data
(63) Continuation-in-part of application No. 16/023,449, filed on Jun. 29, 2018.

(51) Int. Cl. G06T 1/00; G06F 15/18; G06T 7/00; B25J 9/16; G06T 7/194

(52) U.S. Cl. CPC G06T 1/0014; G06F 15/18; G06T 2207/20081; B25J 9/1697; G06T 7/194; G06T 7/0004

(57) ABSTRACT

A system and method for using images for automatic visual inspection with machine learning are disclosed. A particular embodiment includes an inspection system to: train a machine learning system to detect defects in an object based on training with a set of training images including images of defective and non-defective objects; enable a user to use a camera to capture a plurality of images of an object being inspected at different poses of the object; and detect defects in the object being inspected based on the plurality of images of the object being inspected and the trained machine learning system.

### PRIORITY PATENT APPLICATION

This is a continuation-in-part patent application claiming priority to U.S. non-provisional patent application Ser. No. 16/023,449, filed on Jun. 29, 2018. This present patent application draws priority from the referenced patent application. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016-2018 Photogauge, Inc., All Rights Reserved.

### TECHNICAL FIELD

This patent application relates to computer-implemented software systems, mobile device imaging systems, and object automatic visual inspection systems, according to one embodiment, and more specifically to a system and method for using images for automatic visual inspection with machine learning.

### BACKGROUND

Visual inspection instruments using machine vision technology are conventionally used in quality assurance for parts and assemblies of machines, medical devices, semiconductor products, etc. Most commercially available machine vision systems for visual inspection are desktop-sized or larger. In general, such systems lack mobility and flexibility given that a large percentage of visual inspections are manually performed in workshops, office spaces, and at other sites remote from convenient desktop-sized machine vision system access. Moreover, the algorithms used in conventional machine vision systems are inflexible and typically lack the ability to learn from experience. On the other hand, conventional mobile imaging systems offer portability and ease of use; however, they lack the precision and resolution necessary to produce accurate visual inspection and defect detection for objects with complex shapes.

### SUMMARY

In various example embodiments described herein, a system and method for using images for automatic visual inspection with machine learning are disclosed. In the various example embodiments described herein, a computer-implemented device including a software application (app) as part of an inspection system is described to automate and improve object visual inspection processes. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system. An example embodiment can also use one or more cameras, including non-specialty cameras, such as any commodity cameras including mobile phone cameras, mobile phone attachments for image capture, fixed-lens rangefinder cameras, digital single-lens reflex (DSLR) cameras, industrial machine vision cameras, drone cameras, helmet cameras, or the like. The cameras are used to acquire images of an object or images of many objects, from which the inspection system can identify visual defects on parts/objects by using a trained machine learning (ML) based inspection system. In a different embodiment, images obtained using other techniques such as X-ray imaging, CT scan, ultrasonography etc. may also be used instead. The ML-based inspection system can then be trained with a set of training images depicting acceptable and unacceptable parts/objects or object features and used to detect visual or dimensional defects on parts, objects or assemblies. The dimensions of the detected defects can also be measured and tracked.

The inspection system of the various example embodiments described herein provides a system to automatically image a part/object to be inspected or guide the user with the part/object to be inspected and to automatically take photos or images of the part/object. The object(s) may be imaged in a special enclosure or in an environment with a background of a specific color. Alternatively, the object(s) may be imaged in their natural environments. In the example embodiments, the inspection system can analyze the images of the object for focus, lighting, and contrast, and apply an object bounding box around the object. The images can be uploaded to a server in a network cloud for processing or processed locally on an imaging device, a mobile device, a personal computer, a workstation etc. The image processing device (e.g., imaging device, mobile device, server, etc.) can use the images and the trained ML system to identify visual defects on the parts/objects. The ML system can be trained with a set of training images depicting acceptable and unacceptable parts/objects or object features. The inspection system can then use the trained ML system to identify visual defects on the parts/objects.

The example embodiments as described herein can use any type of camera, including a non-specialty camera or any commodity camera, such as one in a mobile phone, mobile phone attachment, a fixed-lens rangefinder camera, DSLR, industrial machine vision camera, drone camera, helmet camera etc., to acquire images of an object, analyze the images, and inform the user in real time if the object contains any defects. Applications of the embodiments described herein include, for example, a) detection of defects such as voids/pores, scratches, dents, or cracks in manufactured parts, b) detection of undersized/oversized/missing features/components in assemblies and c) dimensional ‘defects’, including defects in various dimensions, geometric features, etc. that are out of specified ranges. The dimensions of the detected defects can also be measured and tracked. The system of various example embodiments may include automation to inspect different parts of an object as well as to move parts in sequence (e.g., using a conveyor belt, a robot arm, etc.) so that parts may be fully inspected continuously (e.g., on an assembly line) without any human intervention. In other example embodiments, parts/objects may be imaged using specially prepared hardware or imaged in their natural environments. In one embodiment, specialized hardware can be provided to ensure that objects are imaged in the same orientation and under the same lighting conditions at all times. The hardware may consist of mechanical fixtures or rigs to align the camera in a desired fixed position with respect to the part to be inspected and securing the camera in place. In other embodiments, objects may be imaged in their natural environment without any additional hardware to ensure the same orientation or lighting. These various example embodiments are described in more detail below.

### BRIEF DESCRIPTION OF THE DRAWINGS

The various embodiments are illustrated by way of example, and not by way of limitation, in the figures of the accompanying drawings in which:

FIG. 1 illustrates an example embodiment of a networked system in which various embodiments may operate;

FIGS. 2 through 4 illustrate example embodiments of the visual inspection studio platform;

FIG. 5 illustrates an example embodiment of the visual inspection studio platform wherein a mobile device with a camera (e.g., a smartphone with an application or app) on a customized rig can image an object;

FIG. 6 illustrates an example embodiment of the visual inspection studio platform wherein a mobile device with a camera (e.g., a smartphone with an app) on a customized rig can image an object, the visual inspection studio platform including lamps and an edge sensor;

FIG. 7 illustrates an example image of a portion of an object being inspected (e.g., a gear) as captured using the visual inspection studio platform, wherein the captured image shows a good (non-defective) flank surface of the object being inspected;

FIG. 8 illustrates example images of portions of an object being inspected (e.g., a gear) as captured using the visual inspection studio platform, wherein the captured images show a defective flank surface of the object being inspected;

FIGS. 9 through 12 illustrate example X-ray images of portions of a manufactured object being inspected, wherein the captured images show various types of defects in the object being inspected;

FIGS. 13 and 14 are operational process flow diagrams that illustrate the part/object visual inspection features of the object visual inspection processing module of an example embodiment;

FIG. 15 illustrates another example embodiment of a networked system in which various embodiments may operate;

FIG. 16 illustrates a processing flow diagram that illustrates example embodiments of methods as described herein; and

FIG. 17 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method for using images for automatic visual inspection with machine learning are disclosed. In the various example embodiments described herein, a computer-implemented device including a software application (app) as part of an inspection system is described to automate and improve object visual inspection processes. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system. An example embodiment can also use one or more cameras, including non-specialty cameras, such as any commodity cameras including mobile phone cameras, mobile phone attachments for image capture, fixed-lens rangefinder cameras, digital single-lens reflex (DSLR) cameras, industrial machine vision cameras, drone cameras, helmet cameras, or the like. The cameras are used to acquire images of an object or images of many objects, from which the inspection system can identify visual defects on parts/objects by using a trained machine learning (ML) based inspection system. In a different embodiment, images obtained using other techniques such as X-ray imaging, CT scan etc. may also be used instead. The ML-based inspection system can then be trained with a set of training images depicting acceptable and unacceptable parts/objects or object features and used to detect visual or dimensional defects on parts, objects or assemblies. The dimensions of the detected defects can also be measured and tracked.

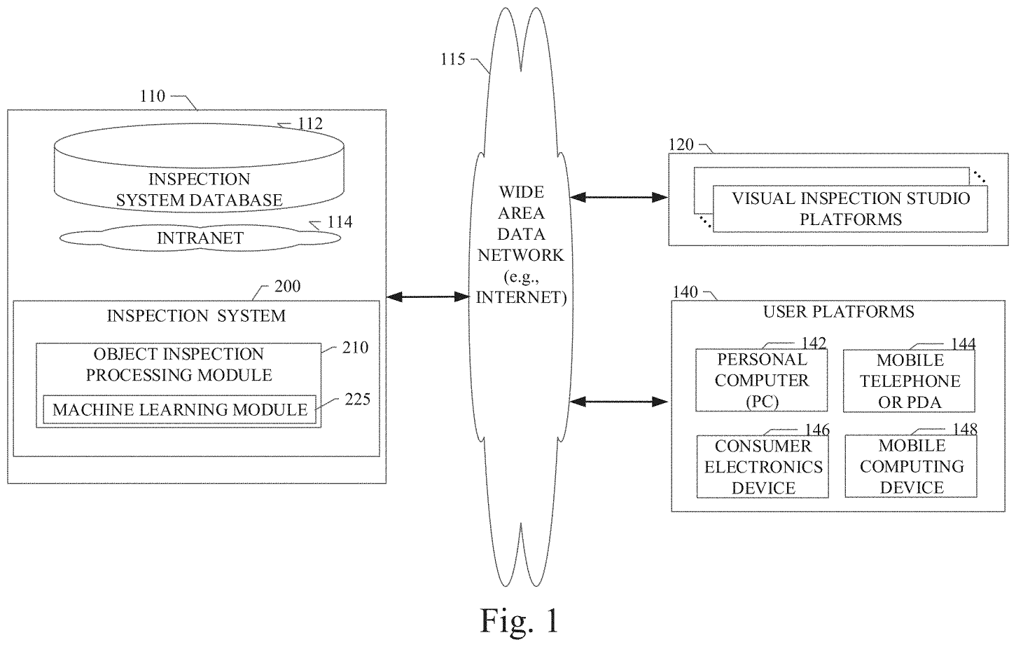

FIG. 1, in an example embodiment, illustrates a system and method for using images for automatic visual inspection with machine learning. In various example embodiments, an application or service, typically provided by or operating on a host site (e.g., a website) 110, is provided to simplify and facilitate the downloading or hosted use of the inspection system 200 of an example embodiment. In a particular embodiment, the inspection system 200, or portions thereof, can be downloaded from the host site 110 by a user at a user platform 140 and used locally at an imaging device or mobile device, for example. Alternatively, the inspection system 200 can be hosted by the host site 110 for a networked user at a user platform 140. The details of the inspection system 200 for an example embodiment are provided below.

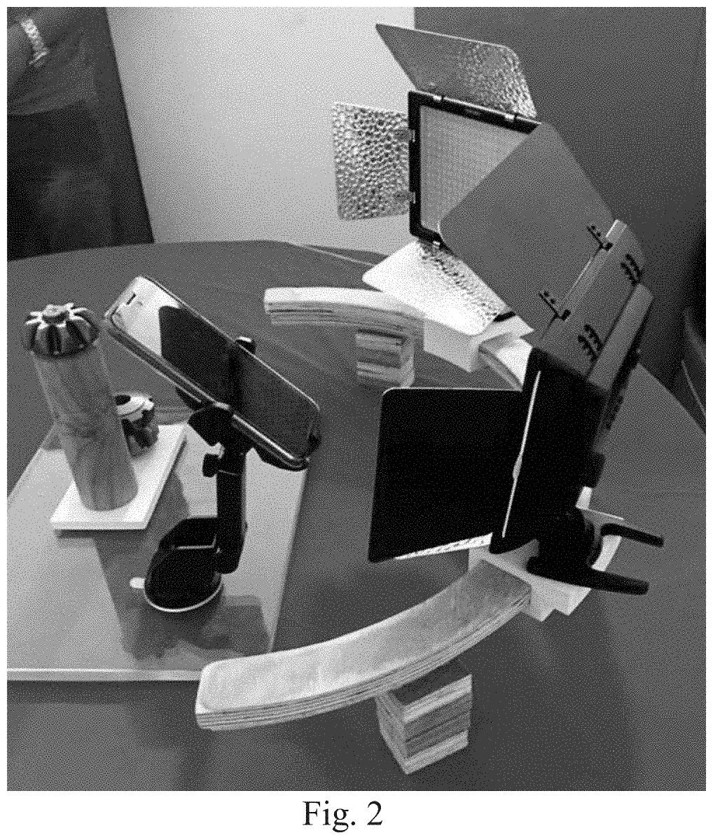

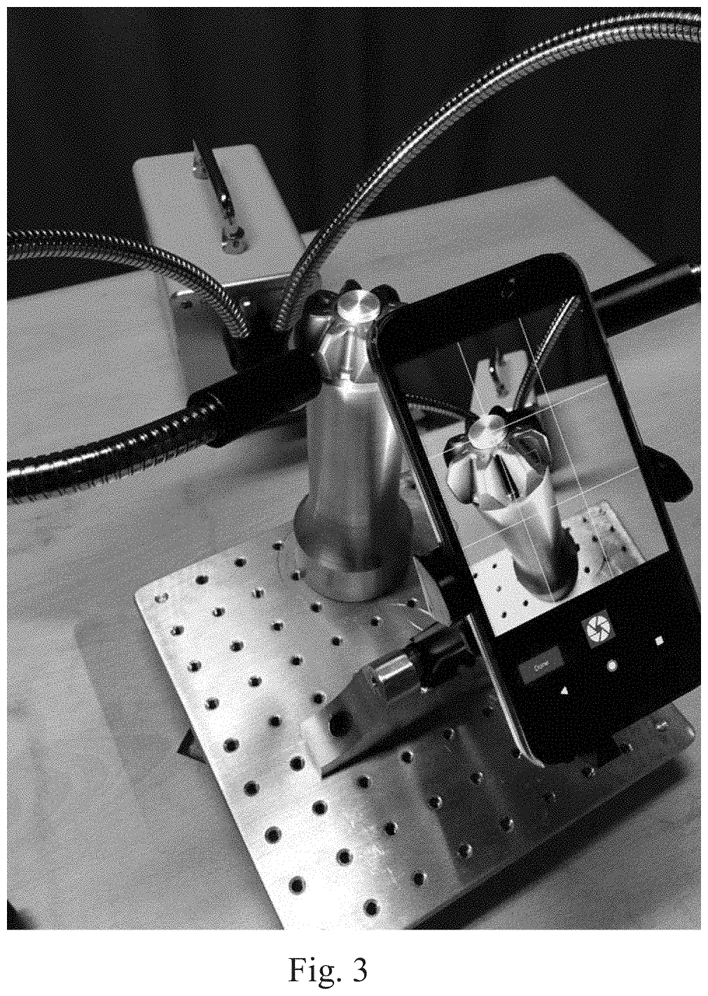

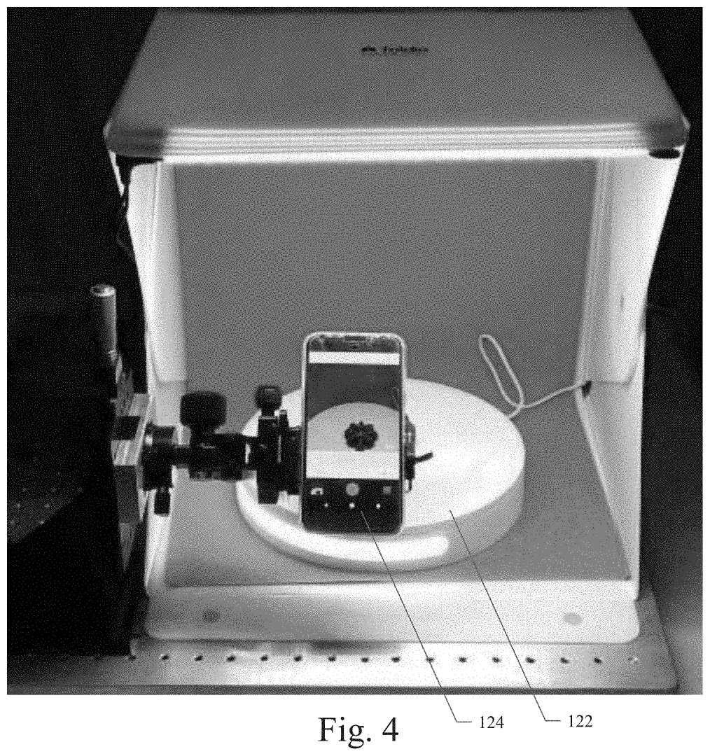

Referring again to FIG. 1, the inspection system 200 can be in network communication with one or a plurality of visual inspection studio platforms 120. The visual inspection studio platforms 120 can include user platform computing and/or communication and imaging devices, studio structures, lighting, and other resources with which parts or objects to be inspected are located. In an example embodiment, the visual inspection studio platforms 120 can include studio structures in which a part/object to be inspected is placed and secured with a retention device. The studio structure enables the automated capture of images or photos of the part/object in a consistent and systematic manner. FIGS. 2 through 4 illustrate example embodiments of the visual inspection studio platforms 120. In a particular embodiment, the studio structure of the visual inspection studio platforms 120 can include a turntable 122 that rotates at intervals and degrees as controlled by the computing and/or communication and imaging device 124, such as a camera phone with an installed software application (app). As described in more detail below, the software application on the computing and/or communication and imaging device 124 can be the downloaded inspection system 200, or a portion thereof. In an example embodiment, the visual inspection studio platforms 120 can further include a set of computer-controllable lights that shine on the part/object being inspected. The inspection system 200 can be configured to control the set of lights of the studio platform 120 to automatically turn on/off each light and automatically capture a photo or image of the part/object with the computing and/or communication and imaging device 124. In this manner, a set of images of the part/object from different angles and with different lighting conditions can be generated. This set of images of the part/object being inspected can be processed by the inspection system 200 as described in more detail below.

In other example embodiments, the inspection system provides a system to automatically image a part/object to be inspected or guide the user with the part/object to be inspected and to automatically take photos or images of the part/object. The object(s) may be imaged in a special enclosure or in an environment with a background of a specific color (e.g., the visual inspection studio platform 120). Alternatively, the object(s) may be imaged in their natural environments at a site other than a studio. Even in the natural environment, a mobile device with the camera (e.g., a drone with camera) can be in data communication with the network. In the example embodiments, the inspection system can analyze the images of the object for focus, lighting, and contrast, and apply an object bounding box around the object. The images can be uploaded to a server 110 in a network cloud 115 for processing or processed locally on an imaging device or a mobile device. The image processing device (e.g., imaging device, mobile device, or server 110), and the inspection system 200 therein, can use the uploaded images and the trained machine learning (ML) module 225 to identify visual defects on the parts/objects represented in the uploaded images. The ML module 225 can be trained with a set of training photos including images depicting acceptable and unacceptable parts/objects or object features. The training photos can be images from ordinary cameras, camera phones, or other types of imaging devices. The inspection system 200 can use the trained ML module 225 to identify visual defects on the parts/objects and provide any of a number of outputs related to the object as generated by the inspection system 200 of the various example embodiments. The outputs can be provided to a user via a user platform, mobile device, email, web browser, or other presentation platform as described in more detail below.

In various example embodiments, one or more of the visual inspection studio platforms 120 can be provided by one or more third party providers operating at various locations in a network ecosystem. It will be apparent to those of ordinary skill in the art that visual inspection studio platforms 120 can include or be any of a variety of networked third party service providers as described in more detail below. The visual inspection studio platforms 120 can also include natural environments within which a part/object to be inspected is located. In a particular embodiment, a resource list maintained at the host site 110 can be used as a summary or list of all visual inspection studio platforms 120, which users or the host site 110 may visit/access and from which users or the host site 110 can obtain part/object images and visual inspection information. The host site 110, visual inspection studio platforms 120, and user platforms 140 may communicate and transfer data and information in the data network ecosystem shown in FIG. 1 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The visual inspection studio platforms 120 and/or the user platforms 140 may include any of a variety of providers or consumers of network transportable digital data. The network transportable digital data can be transported in any of a family of file formats, protocols, and associated mechanisms usable to enable a host site 110 and a user platform 140 to send or receive images of parts/objects and related analysis information over the network 115. In example embodiments, the file format can be a Joint Photographic Experts Group (JPEG) file, a Portable Document Format (PDF), a Microsoft™ Word document or Excel spreadsheet format, a CSV (Comma Separated Values) format; however, the various embodiments are not so limited, and other file formats and transport protocols may be used. For example, other data formats or formats other than open/standard formats can be supported by various embodiments. Any electronic file format, such as Microsoft™ Access Database Format (MDB), audio (e.g., Motion Picture Experts Group Audio Layer 3—MP3, and the like), video (e.g., MP4, and the like), and any proprietary interchange format defined by specific sites can be supported by the various embodiments described herein. Moreover, a visual inspection studio platform 120 and/or user platform 140 may provide a variety of different data sets or computational modules.

In a particular embodiment, a user platform 140 with one or more client devices enables a user to generate data or access data provided by the inspection system 200 via the host 110 and network 115. Client devices of user platform 140 may include virtually any computing device that is configured to send and receive information over a network, such as network 115. Such client devices may include portable devices 144, such as, cellular or satellite telephones, smartphones, imaging devices, radio frequency (RF) devices, infrared (IR) devices, global positioning devices (GPS), drones, Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146, such as imaging devices, and/or mobile computing devices 148, which are known to those of ordinary skill in the art. As such, the client devices of user platform 140 may range widely in terms of capabilities and features. In most cases, the client devices of user platform 140 will include an image capturing device, such as a camera. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to capture or receive image data, analysis data, and/or control data from another computing device via a wired or wireless network transmission. The client application may include a capability to provide and receive textual data, image data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 1, the inspection system 200 of an example embodiment is shown to include an inspection system database 112. The database 112 can be used to retain a variety of information data sets including, but not limited to, parts/object information, parts or objects listing information, image data, parts/object analytics, control data, training data, and the like. It will be apparent to those of ordinary skill in the art that the inspection system database 112 can be locally resident at the host site 110, remotely located at other server locations, stored in network cloud storage, or stored in whole or in part on a client device of user platform 140.

Referring again to FIG. 1, host site 110 of an example embodiment is shown to include the inspection system 200. In an example embodiment, inspection system 200 can include an object inspection processing module 210 and a machine learning (ML) module 225. Each of these modules can be implemented as software components executing within an executable environment of inspection system 200 operating on host site 110 or user platform 140. Each of these modules of an example embodiment is described in more detail below in connection with the figures provided herein.

Referring still to FIG. 1, the inspection system 200 can include an object inspection processing module 210. The object inspection processing module 210 can be configured to perform the processing as described herein. In a particular example embodiment, the object inspection processing module 210 can be configured to provide a system to automatically image a part/object to be inspected or guide the user with the part/object to be inspected and to automatically take photos or images of the part/object. In various embodiments, the object inspection processing module 210 can acquire one or multiple images of the object or objects. The object(s) may be imaged in a special enclosure or in an environment with a background of a specific color (e.g., the visual inspection studio platform 120). Alternatively, the object(s) may be imaged in their natural environments at a site other than a studio. Even in the natural environment, the mobile device with the camera can be in data communication with the network 115. Irrespective of whether images are obtained using the same camera or multiple cameras, the images are processed in a similar way. In one embodiment, images of the object or objects can be captured in different poses using a single camera or multiple cameras by rotating or translating the object on a moving platform, such as a manual or automatic turntable, a conveyor belt, a drone, a robot, a robotic-arm, or by manually moving the camera and capturing images from different camera locations. In the example embodiments, the object inspection processing module 210 can analyze the images of the object for focus, lighting, and contrast, and apply an object bounding box around the object. The images can be uploaded to the server 110 in a network cloud and processed by the object inspection processing module 210 hosted on the server 110. Alternatively, the object inspection processing module 210 can be downloaded and executed locally on an imaging device or a mobile device of user platform 140. In either case, the object inspection processing module 210 can identify visual defects on parts/objects by using the images from ordinary cameras, camera phones, or other types of imaging devices and by using the trained ML module 225. The ML module 225 can be trained with a set of training photos including images depicting acceptable and unacceptable parts/objects or object features. The training photos can be images from ordinary cameras, camera phones, or other types of imaging devices. The object inspection processing module 210 can use the trained ML module 225 to identify visual or dimensional defects on the parts/objects and provide any of a number of outputs related to the object as generated by object inspection processing module 210 of the various example embodiments. The outputs can be provided to a user via a user platform, mobile device, email, web browser, or other presentation platform of user platform 140.

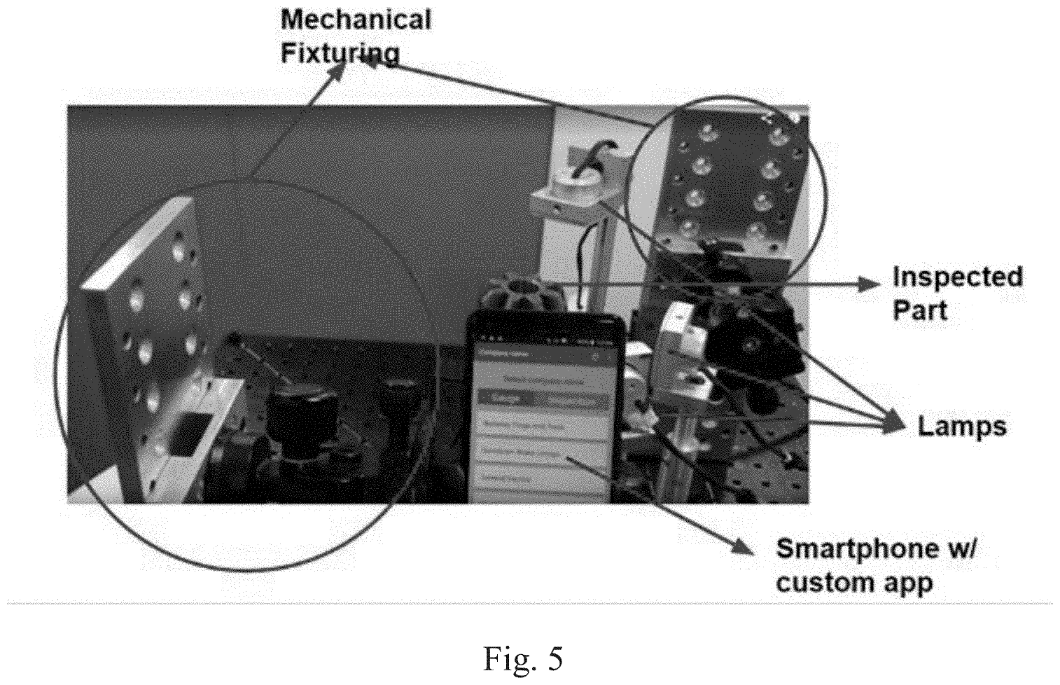

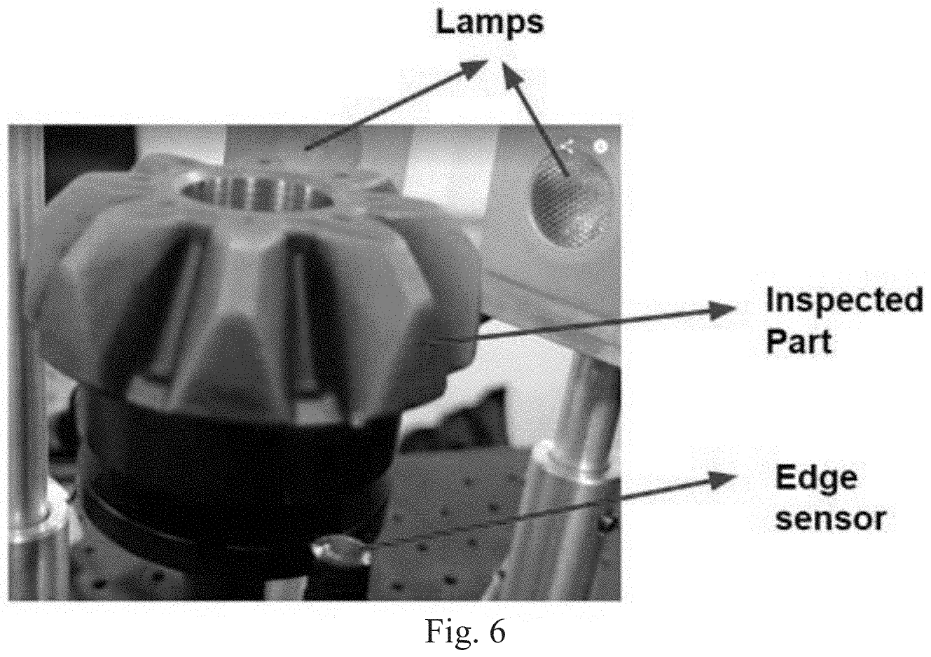

FIG. 5 illustrates another example embodiment of the visual inspection studio platform wherein a mobile device with a camera (e.g., a smartphone with an application or app) on a customized mechanical fixture or rig can image an object. FIG. 5 illustrates an example embodiment of the visual inspection studio platform wherein an object can be placed in or on an automated pedestal for automatic image acquisition. In the example shown, an object is positioned on an automatic pedestal adjacent to an imaging device (e.g., a smartphone with a camera) on which an instance of the object inspection processing module 210 can be executed as a mobile device app. The imaging device can be positioned and retained using a mechanical fixture or rig. The position and angle of the imaging device relative to the object being imaged can be precisely controlled with the mechanical fixture or rig. Automatically controlled lamps or lights (a lamp array) and edge sensors can also be placed adjacent to the object being imaged (e.g., see FIG. 6). In the example embodiment shown in FIGS. 5 and 6, the mobile device app (e.g., the object inspection processing module 210, or portion thereof) can be configured to send wireless commands to the automated pedestal and the lamp array through a Bluetooth™ or WiFi data transmission. The wireless commands can cause the automated pedestal to move in a precisely controlled manner and amount to position the automated pedestal and the object thereon in a precise location or position. The wireless commands can also cause the lamp array to illuminate the object with varying intensity and color. The mobile device app can then cause the camera of the imaging device to acquire an image of the object after the automated pedestal and the lamp array have been appropriately controlled. The process can be repeated for multiple positions, lightings, and images of the object. Once all angles and lightings of the object are covered, the mobile device app can upload the automatically acquired images of the object to the server 110 for processing. In a similar manner as described above, the set of images of the object can be captured and used by the object inspection processing module 210 to identify visual defects on the parts/objects by using the trained ML module 225. The object inspection processing module 210 can identify visual defects on the parts/objects and provide any of a number of outputs corresponding to the visual inspection results. Once the object inspection processing module 210 completes the processing of the object images, the object inspection processing module 210 can send the processed data to a user platform or mobile device or present the processed data on a display of the user platform or mobile device.

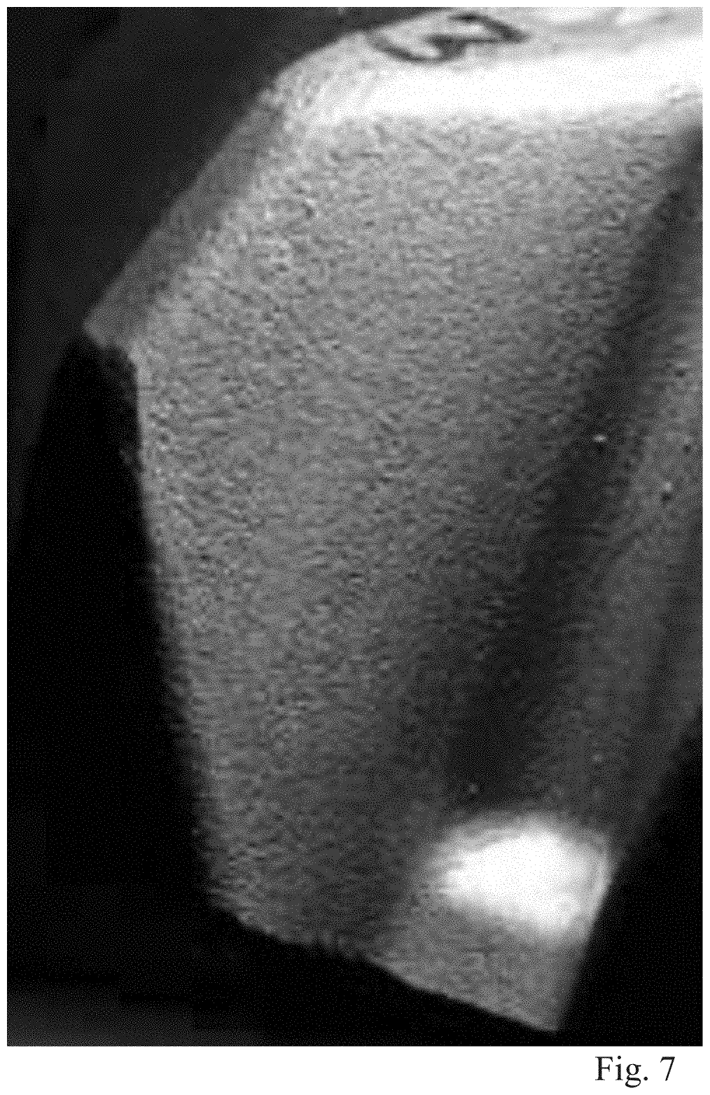

FIG. 7 illustrates an example image of a portion of an object being inspected (e.g., a gear) as captured using an embodiment of the visual inspection studio platform as described herein. The sample image shows a good (non-defective) flank surface of the object being inspected.

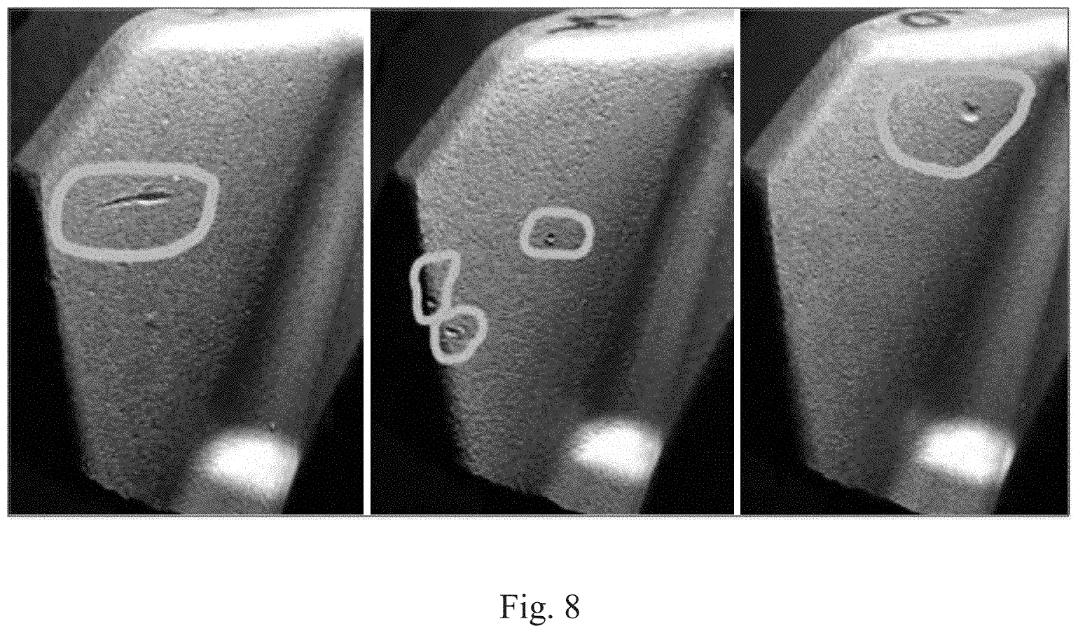

FIG. 8 illustrates example images of portions of an object being inspected (e.g., a gear) as captured using an embodiment of the visual inspection studio platform as described herein. The sample images show a defective flank surface of the object being inspected. The defects can be detected by use of the trained ML module 225 to differentiate between a non-defective portion of the object and a defective portion of the object.

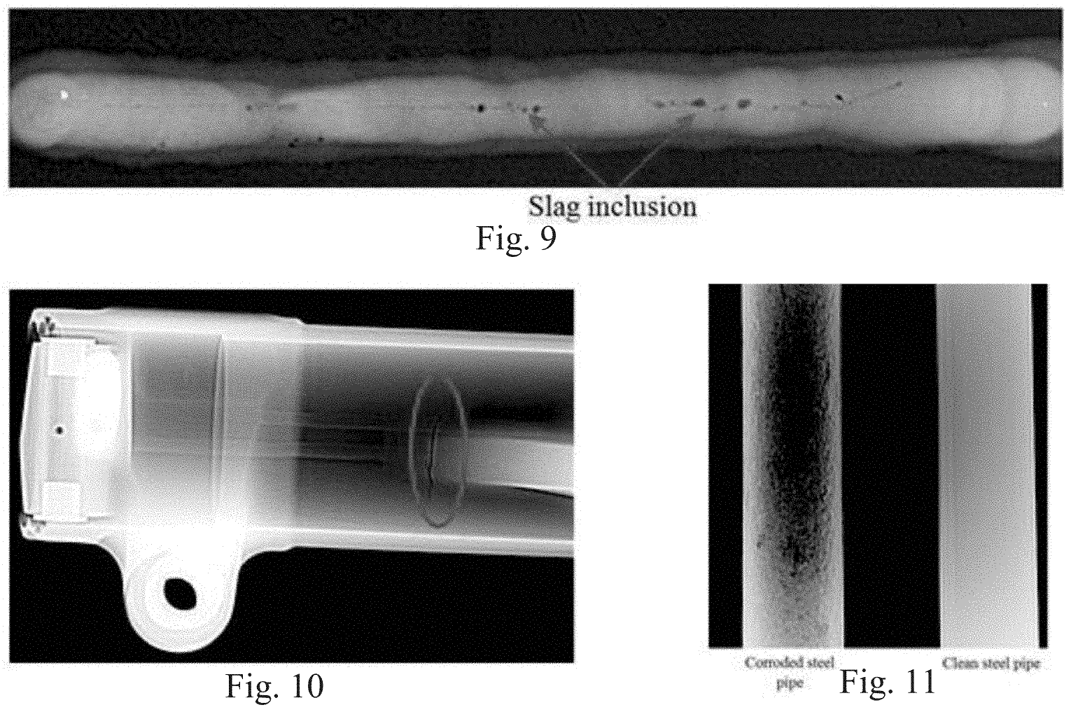

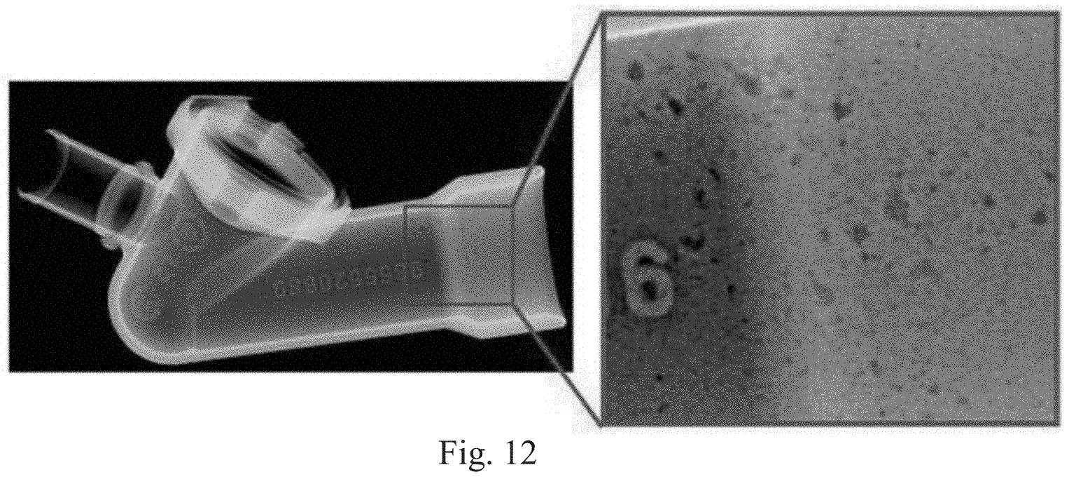

FIGS. 9 through 12 illustrate example X-ray images showing portions of a manufactured object being inspected, wherein the captured images show various types of defects in the object being inspected. In the various example embodiments described herein, the captured images of the object can be in a variety of forms including, X-ray, CT scan (computed tomography scan), MRI (magnetic resonance imaging), ultrasound, nuclear medicine imaging, positron-emission tomography (PET), or the like. The defects of an object shown in the captured images can be detected by use of the trained ML module 225 to differentiate between a non-defective portion of the object and a defective portion of the object.

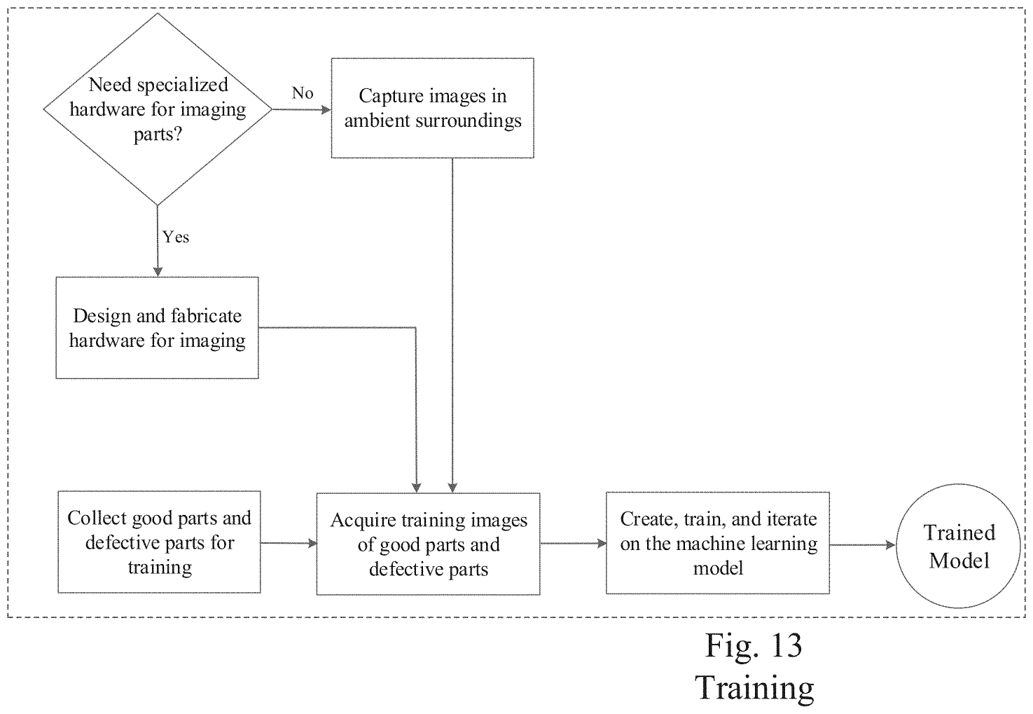

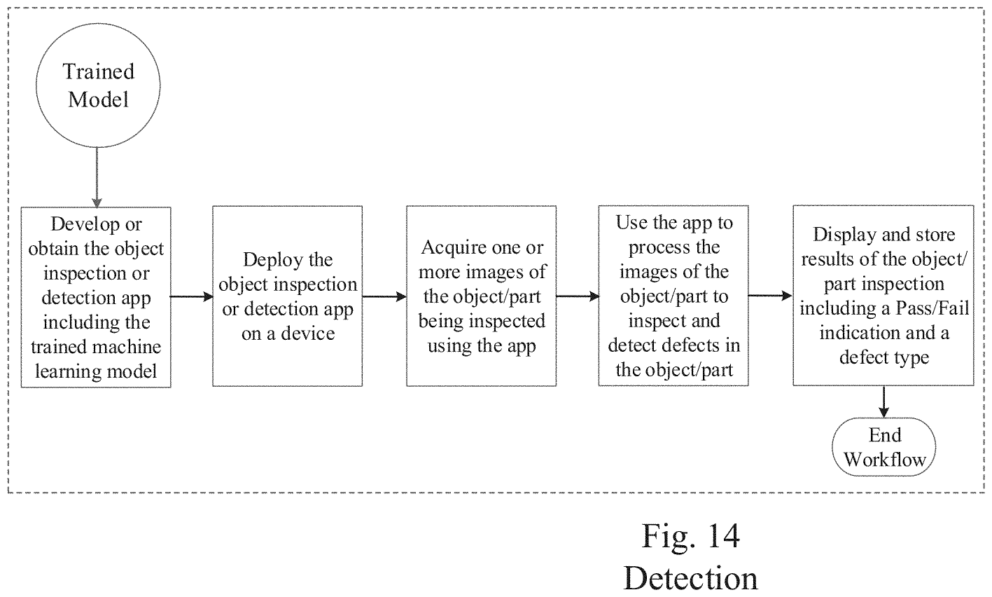

FIGS. 13 and 14 are operational process flow diagrams that illustrate the part/object visual inspection features of the object inspection processing module 210 of an example embodiment. In general, the object inspection processing module 210 of the various example embodiments described herein provides automated object inspection and defect detection features. The object inspection processing module 210 provides a solution for identifying visual defects on parts/objects by using images from ordinary cameras, camera phones, or other types of imaging devices.

Referring now to FIG. 13, the object inspection processing module 210 can initially perform a training phase to train the machine learning (ML) module 225 to recognize acceptable and unacceptable or defective parts/objects and/or features thereof. As part of the training phase, the object inspection processing module 210 can collect or receive a large set of training photos or images depicting acceptable parts/objects or object features without significant defects. The set of training photos or images, labelled as depicting acceptable parts/objects or object features, can be collected or received using the camera, camera phone or other imaging device. The object inspection processing module 210 can also collect or receive a large set of training photos or images depicting unacceptable parts/objects or object features with defects requiring attention. In general, an unacceptable part/object or object feature is one with visible physical defects on the surface such as nicks, dings, cracks, or discoloration. The set of training photos or images, labelled as depicting unacceptable parts/objects or object features, can also be collected or received using the camera, camera phone, or other imaging device. The set of training photos including images depicting acceptable and unacceptable parts/objects or object features can be used to train a machine learning (ML) system, such as a deep convolutional neural network, represented as machine learning module 225 shown in FIG. 1. As a result, the trained machine learning system or ML model (machine learning module 225) can be configured to distinguish between or recognize acceptable and unacceptable parts/objects or object features depicted in new or original images presented to the trained machine learning module 225. The datasets and executables corresponding to the trained machine learning module 225 can be optionally downloaded to the camera, camera phone, or other imaging device or user platform and executed locally thereon.

As shown in FIG. 13, the acquisition of training images can be performed using specialized hardware for imaging objects, such as the studio environments described herein. Alternatively, the acquisition of training images can be performed in the natural or ambient surroundings at which objects of interest can be found. For example, training images of a pipeline, or other object to be inspected, can be acquired by a drone or camera crew deployed into the field. Similarly, training images of other types of objects can be acquired in their natural surroundings. The captured images can be labelled as depicting defective or non-defective objects or object features. The collection of training images can be acquired and used in the training phase by the object inspection processing module 210 to train the ML module 225 to detect defects in features of objects being inspected. Multiple iterations in the training phase over a large set of training data can produce a trained ML module 225 configured to detect defects in features of objects being inspected. The parameters of the trained ML module 225 can be saved and transferred to a desired processing platform for use during an operational or detection phase where a new set of objects can be automatically visually inspected for defects.

In the training phase, ‘ground truth data’ are collected and used with or as the training data. The ground truth data, comprising images of known good and known defective parts, are collected, imaged, processed and carefully labeled as ‘good’ or ‘defective’, respectively. Often, the same object may be imaged under a series of different lighting conditions to highlight different surface features. Customized hardware, as described above, may be used to obtain these ground truth data. An artificial intelligence or machine learning model (such as ML module 225), which is a mathematical model that may use any of a number of public and proprietary processes, can be built and trained with the ground truth data until the model is able to predict whether a given object is good or defective repeatedly and accurately. At this stage, the model is said to be trained. This trained model (e.g., trained ML module 225) can then be transferred to a mobile device (such as a smartphone or tablet) or other device such as a desktop or laptop computer or workstation.

Often, surfaces of parts/objects may show surface discolorations, oil stains, etc., which are not considered defects. A good visual inspection system must be able to classify such parts as ‘good’ while flagging the truly defective ones. This is potentially challenging for an image-based system. The various example embodiments described herein use multiple images in the training data for the same part under different lighting conditions to achieve this goal. Specifically, the ratios of luminosities of the same image pixel location across the multiple images can be computed and used to train the machine learning model for this purpose.

Referring now to FIG. 14, once the machine learning module 225 is trained and optionally downloaded as described above, the object inspection processing module 210 can generate a user interface via a client device of user platform 140 as part of the operational or detection phase to provide the client device user with an option to collect new or original images of a part/object to be inspected. The new images can be collected using the camera, camera phone, or other imaging device. The object inspection processing module 210 can perform an alignment check to verify that the part/object to be inspected has been properly aligned for imaging.

In a manual mode of operation, the object inspection processing module 210 can assist the user to manually take pictures of the part/object once the part/object is aligned. The object inspection processing module 210 can provide this user assistance via a user interface and associated prompts on the imaging device 124. In an automated mode of operation, the object inspection processing module 210 can generate and issue commands for example, to a turntable 122 for rotation of the turntable 122 and the part/object thereon to a particular orientation or view for the camera of the imaging device 124. After rotation of the turntable 122 is complete, the imaging device 124 can receive a response signal back from the turntable 122 indicating the turntable 122 has completed the rotation to the desired position. Then, the imaging device 124 can automatically capture an image or a plurality of images of the part/object being inspected at the particular rotation of the turntable 122 and exposing a particular orientation or view of the part/object. The imaging device 124 can automatically take a photo or image of the part/object and then prepare for the next image in a sequence of images of the part/object being inspected. The automatic image capture process of the object inspection processing module 210 can continue without user intervention until a previously specified number or quantity of images in the sequence of images of the part/object have been captured.

In other embodiments, a part/object can be imaged for inspection in a variety of ways. For example, a collection of small parts/objects can be poured into a large funnel hopper, which gets vibrated causing one part/object at a time to shake out of the funnel at the bottom and onto a conveyor belt. This part/object then moves along on the conveyor belt and gets placed into different orientations in front of a series of cameras adjacent to the conveyor belt. The series of cameras can capture a set of images of each part/object as it moves past the cameras adjacent to the conveyor belt. This set of images of each part/object can be used by the object inspection processing module 210 to analyze the images and identify object defects as described herein. It will be apparent to those of ordinary skill in the art in view of the disclosure herein that other means for imaging a part/object being inspected may be similarly used.

In an example embodiment, the object inspection processing module 210 can enable a user to specify a number or quantity of images of a particular part/object to be acquired to accomplish proper inspection of the part/object. The object inspection processing module 210 can also prompt the user to adjust the lighting in the visual inspection studio platform 120 to properly illuminate the part/object for image capture. In an automated mode of operation, the object inspection processing module 210 can automatically adjust the lighting in the visual inspection studio platform 120 to properly illuminate the part/object for each image capture. As described above, the object inspection processing module 210 can also generate and issue commands to the turntable 122 for rotation of the turntable 122 and the part/object thereon to a particular orientation or view for the camera of the imaging device 124. As also described above, the imaging device 124 can automatically capture a sequence of photos or images of the part/object, automatically rotating the turntable 122 for each image capture. The automatic image capture process of the object inspection processing module 210 can continue without user intervention until the previously specified number or quantity of images in the sequence of images of the part/object have been captured.

In one example embodiment, the object inspection processing module 210 can gather an entire sequence of images of the part/object and then conduct inspection processing on the entire image sequence. In another embodiment, the object inspection processing module 210 can conduct inspection processing after the capture of each individual image. In either case, the processing flow illustrated in FIG. 14 can be performed by the object inspection processing module 210 during an operational phase of the system.

Referring again to FIG. 14, as described above, the trained machine learning module 225 can be downloaded and made locally resident on the camera, camera phone, or other imaging device. Given the trained machine learning module 225, the object inspection processing module 210 can process each image of the sequence of images using the trained machine learning module 225. In particular, the object inspection processing module 210 can perform feature extraction from each captured image of the part/object being inspected and pass the image and the extracted features to the trained machine learning module 225 locally resident on the camera, camera phone, or other imaging device. The trained machine learning module 225 can use the image and the extracted features to distinguish between and recognize acceptable and unacceptable (defective) features of the parts/objects depicted in the captured image. Based on the processing performed by the trained machine learning module 225, the object inspection processing module 210 can generate or receive inspection results corresponding to the inspection analysis of the image(s) of the part/object. In particular, the generated or received inspection results can include an identification of the features of the part/object that were analysed and information indicative of whether the analysed features were determined to be acceptable or defective. Thus, the inspection system 200, and the object inspection processing module 210 therein, can generate output corresponding to the inspection results including information indicative of whether the part/object being inspected was determined to be an acceptable or defective part/object. The inspection results can include an indication of whether the inspected object passed or failed the inspection process.

In the operational or detection phase, the mobile or other device loaded with the trained model can be deployed and used to predict if a given part (that is not part of the ground truth data set) is good or defective. This is done by acquiring the same kind of images that were acquired during the ground truth data collection of the training phase. These images are then processed as required and fed to the trained model residing on the device. The trained model then predicts (usually in real time) if the object is good or defective. The inspection results may be shown in text form on the mobile device, shown graphically, or shown using Augmented or Virtual Reality (AR/VR) on the display for better visualization. Based on the inspection results, an example embodiment may also segregate the parts/objects appropriately for further action.

The server 110 or the object inspection processing module 210 itself can use the images to identify visual defects on the parts/objects by using the trained ML module 225. The ML module 225 can be trained with a set of training photos including images depicting acceptable and unacceptable parts/objects or object features. The server 110 or the object inspection processing module 210 can identify visual defects on the parts/objects and provide any of a number of outputs. The server 110 or the object inspection processing module 210 can generate information indicative of the status of the inspection result, such as pass/fail results. In an example embodiment, the user can receive detailed information related to the inspection results in the form of tables, images, or the like. The inspection results, deviation information, and other output related to the inspection of the part/object as generated by the inspection system 200 of the various example embodiments can be provided to the user via the imaging device 124, another mobile device, email, web browser, or other presentation platform.

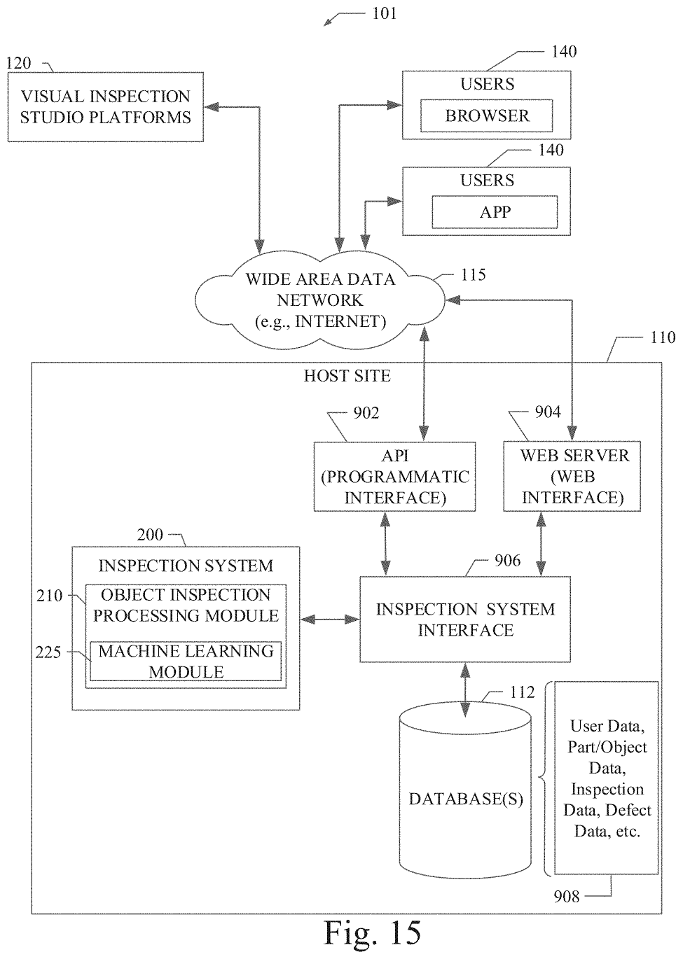

Referring now to FIG. 15, another example embodiment 101 of a networked system in which various embodiments may operate is illustrated. In the embodiment illustrated, the host site 110 is shown to include the inspection system 200. The inspection system 200 is shown to include the object inspection processing module 210 as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the inspection system 200 either directly or via an interface 906. The inspection system 200 may be configured to access a data storage device 112 either directly or via the interface 906.

Thus, as described for various example embodiments, a system and method for using images for automatic visual inspection with machine learning are disclosed. In the various example embodiments described herein, a computer-implemented device including a software application (app) as part1improve object visual inspection processes. The various embodiments described herein can be expanded in a variety of ways to provide additional features and services. Some of these expanded features and services are provided to create and manage a secure infrastructure in a cloud environment to provide computational resources and technology services for inspection of parts/objects and distributing inspection reports across platforms. Various example embodiments can also provide the following features and services:
API services across platforms for interaction with user content and data access
Data storage services using industrial grade services
Continuous integration and deployment of all services over cloud infrastructure
Communication of all components and resources using authentication and authorization over secure channel.
Periodic, logical backups for disaster recovery
Horizontal scaling of complete infrastructure
Version control system for application code management
24/7 availability of infrastructure
Data persistence services in RDBMS

The various embodiments described herein can provide a variety of benefits. For example, the various embodiments can provide among the following benefits and capabilities:
Using a smartphone for object imaging
One-touch object inspection using a smartphone
Real-time image quality/fitness assessment for object inspection
Stencil-based user guidance system
Parallelizable workflow with minimal hardware change
Automatic camera position system for perfect object inspection
Visualization of results using augmented reality (AR) on the phone
Drone-based object inspection pipeline
Fully autonomous object inspection pipeline

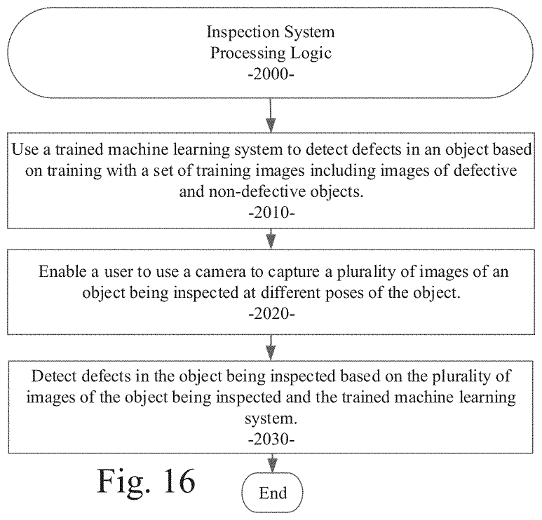

Referring now to FIG. 16, a processing flow diagram illustrates an example embodiment of a method implemented by the inspection system 200 as described herein. The method 2000 of an example embodiment can be configured to: use a trained machine learning system to detect defects in an object based on training with a set of training images including images of defective and non-defective objects (processing block 2010); enable a user to use a camera to capture a plurality of images of an object being inspected at different poses of the object (processing block 2020); and detect defects in the object being inspected based on the plurality of images of the object being inspected and the trained machine learning system (processing block 2030).

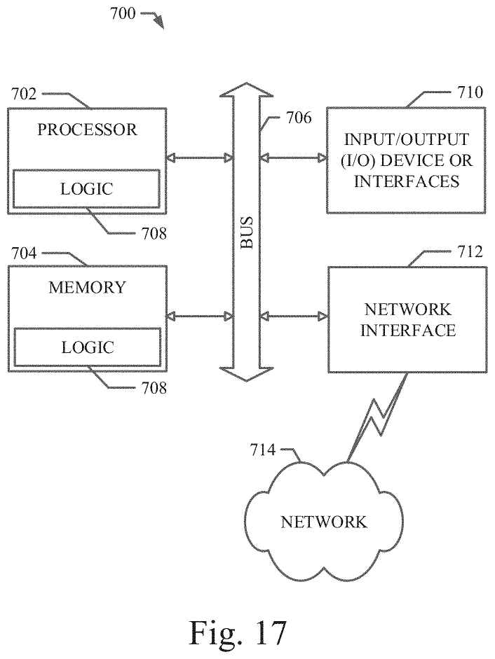

FIG. 17 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

As described herein for various example embodiments, a system and method for using images for automatic visual inspection with machine learning are disclosed. In various embodiments, a software application program is used to enable the capture and processing of images on a computing or communication system, including mobile devices. As described above, in a variety of contexts, the inspection system 200 of an example embodiment can be configured to automatically capture images of a part/object being inspected, all from the convenience of a portable electronic device, such as a smartphone. This collection of images can be processed and results can be distributed to a variety of network users. As such, the various embodiments as described herein are necessarily rooted in computer and network technology and serve to improve these technologies when applied in the manner as presently claimed. In particular, the various embodiments described herein improve the use of mobile device technology and data network technology in the context of automated object visual inspection via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor and a camera; and
an inspection system, executable by the data processor, to:
use a trained machine learning system to detect defects in an object based on training with a set of training images including images of defective and non-defective objects;
enable a user to use the camera to capture a plurality of images of an object being inspected at different poses of the object; and
detect defects in the object being inspected based on the plurality of images of the object being inspected and the trained machine learning system.

2. The system of claim 1 being further configured to cause the inspection system to generate visual inspection information from the plurality of images of the object, the visual inspection information including information corresponding to defects detected in the object being inspected.

3. The system of claim 2 wherein the visual inspection information further including inspection pass or fail information.

4. The system of claim 2 being further configured to cause the inspection system to provide the visual inspection information to a user of a user platform.

5. The system of claim 1 wherein the camera is a device of a type from the group consisting of: a commodity camera, a camera in a mobile phone, a camera in a mobile phone attachment, a fixed-lens rangefinder camera, a digital single-lens reflex (DSLR) camera, an industrial machine vision camera, a drone camera, a robotic-arm based camera, and a helmet camera.

6. The system of claim 1 being further configured to automatically adjust lighting in a visual inspection studio platform to properly illuminate the object being inspected for each image capture.

7. The system of claim 1 being further configured to capture the plurality of images of the object being inspected at different automatic rotations of a turntable without user intervention.

8. The system of claim 1 being further configured to capture the plurality of images of the object being inspected with a commodity camera.

9. The system of claim 1 being further configured to capture the plurality of images of the object being inspected with a drone camera.

10. The system of claim 1 being further configured to capture the plurality of images of the object being inspected with a robotic-arm based camera.

11. The system of claim 1 being further configured to use a colored screen to aid in isolating the object of interest from a cluttered background.

12. The system of claim 1 being further configured to provide real-time image quality or fitness assessments for object visual inspection.

13. A method comprising:
training a machine learning system to detect defects in an object based on training with a set of training images including images of defective and non-defective objects;
enabling a user to use a camera to capture a plurality of images of an object being inspected at different poses of the object; and
detecting defects in the object being inspected based on the plurality of images of the object being inspected and the trained machine learning system.

14. The method of claim 13 including generating visual inspection information from the plurality of images of the object, the visual inspection information including information corresponding to defects detected in the object being inspected.

15. The method of claim 13 wherein the camera is a device of a type from the group consisting of: a commodity camera, a camera in a mobile phone, a camera in a mobile phone attachment, a fixed-lens rangefinder camera, a digital single-lens reflex (DSLR) camera, an industrial machine vision camera, a drone camera, a robotic-arm based camera, and a helmet camera.

16. The method of claim 13 including capturing the plurality of images of the object being inspected with a commodity camera.

17. The method of claim 13 including capturing the plurality of images of the object being inspected with a drone camera.

18. The method of claim 13 including capturing the plurality of images of the object being inspected with a robotic-arm based camera.

19. The method of claim 13 including using a colored screen to aid in isolating the object of interest from a cluttered background.

20. The method of claim 13 including determining the dimensions of the defects detected in the object being inspected.
